(19) United States
(12) Patent Application Publication
(10) Pub. No.: US 2025/0010284 A1
(43) Pub. Date: Jan. 9, 2025

(54) SYSTEM DEVICE AND METHOD FOR QUANTITATIVELY INJECTING TEST SAMPLE INTO CHIP, AND USE THEREOF

(71) Applicant: JIANGSU LOGILET BIOTECH CO., LTD., Suzhou (CN)

(72) Inventors: Pei DU, Suzhou (CN); Yang SU, Suzhou (CN); Yan ZHANG, Suzhou (CN)

(21) Appl. No.: 18/711,012

(22) PCT Filed: Jul. 28, 2022
(86) PCT No.: PCT/CN2022/108704

§ 371 Date: May 16, 2024

(30) Foreign Application Priority Data
Nov. 17, 2021 (CN) 202111359724.1

(51) Int. Cl. B01L 3/02

(52) U.S. Cl. CPC B01L 3/0293; B01L 2200/025; B01L 2200/0684; B01L 2200/0689

(57) ABSTRACT

A system device and method for quantitatively injecting a tested sample into a chip, and a use. The system device is used for injecting a quantitative tested sample into a gap chamber of a chip; the system device comprises a sample quantification assembly and a liquid injection chamber; the sample quantification assembly comprises a body; a quantitative chamber is provided in the body; the liquid injection chamber comprises an open housing; a partition plate is provided in the housing; the partition plate divides the housing into a first chamber and a second chamber; the tested sample is injected into the first chamber; the sample quantification assembly is placed in the liquid injection chamber and is continuously pressed down; the body extends into the first chamber for quantitative injection.

### TECHNICAL FIELD

The present disclosure belongs to the technical field of microfluidic chips and relates to quantitative injection of samples into chips, and in particular to, a system device and method for quantitatively injecting a test sample into a chip, and the use thereof.

### BACKGROUND ART

In the polymerase chain reaction (PCR) process, test personnel need to add test samples in the use of chips after sample collection and treatment. Usually, the test samples are collected in collection tubes, and the volumes of samples to be injected into digital microfluidic chips are certain. If the test samples are quantitatively removed from the collection tubes by means of pipettes, droppers or other liquid quantification tools and then injected into sample inlets of the chips, the number of user's operation steps will be increased and the use scenarios of the digital microfluidic chips will be greatly limited.

CN109652298A discloses a droplet PCR amplification detection device based on a microfluidic chip. The device comprises a droplet microfluidic chip, an XYZ movement unit, a PCR amplification unit, and a detection unit. After a droplet containing DNA molecules is generated, it is introduced into the droplet microfluidic chip by means of a pipette, and the chip is placed in the droplet PCR amplification unit for a PCR amplification reaction.

CN107831811A discloses a micro/nano cellulose microfluidic channel flow control device and a control method therefor. The device comprises: a syringe pump, an injection portion, a sample injection plug, a microfluidic chip, and a sealing film. The syringe pump quantitatively controls the injection flow of a micro/nano cellulose suspension; and the injection portion is configured to contain the micro/nano cellulose suspension and inject the micro/nano cellulose suspension into the microfluidic chip.

CN112271416A discloses a lithium-battery electrolyte injection device using an electrolyte storage cup to inject an electrolyte and a manufacturing method therefor. The structure of the lithium-battery electrolyte injection device comprises a battery case, a holder and an electrolyte storage cup. A detachably connected locking assembly is provided between the electrolyte storage cup and the holder. An electrolyte injection chamber that is sealed through the connection of the locking assembly is provided between the electrolyte storage cup and the top of the battery case. An electrolyte storage chamber for quantitatively storing the electrolyte is provided in the electrolyte storage cup. The electrolyte in the electrolyte storage chamber may be pressed by an external pressure to enter the electrolyte injection chamber first and then be injected into the battery case through an electrolyte injection hole in a one-off manner.

Once the traditional PCR reaction is initiated, it is impossible to add a new reaction group during the reaction. The full-manual operation is time-consuming and labor-intensive. The digital microfluidic chip adopts the principle of electrowetting technology, regulates solid-liquid surface energy by means of electric potential, and drives a liquid to move by virtue of the surface energy imbalance, so as to achieve precise control on micro-liquid. This is greatly dependent on a syringe pump and is costly.

### SUMMARY

Aiming at the disadvantages of the prior art, the present disclosure provides a system device and method for quantitatively injecting a test sample into a chip, and a use. During use of the system device, a sample quantification assembly that comes with the system device may be used to complete quantitative extraction of the required test sample without the need for an additional quantification tool, and to quantitatively inject the test sample, thereby realising automatic injection of the sample into the chip, reducing the dependence on the additional quantification tool, and making the operation more convenient and flexible.

The present disclosure adopts the following technical solutions.

In a first aspect, the present disclosure provides a system device for quantitatively injecting a test sample into a chip. The system device is configured to inject a quantitative test sample into a gap chamber of a chip. The system device comprises a sample quantification assembly and a liquid injection chamber. The sample quantification assembly comprises a body, and a quantitative chamber is provided in the body. The liquid injection chamber comprises an open housing, a partition plate is provided in the housing, the partition plate divides the housing into a first chamber and a second chamber, and the test sample is injected into the first chamber. The sample quantification assembly is placed in the liquid injection chamber and is continuously pressed down such that the body extends into the first chamber for quantitative sample injection.

According to the present disclosure, during use of the system device for quantitatively injecting a test sample into a chip, the sample quantification assembly that comes with the system device may be used to complete quantitative extraction of the required test sample without the need for an additional quantification tool, and to quantitatively inject the test sample, thereby realizing automatic injection of the sample into the chip, reducing the dependence on the additional quantification tool, and making the operation more convenient and flexible.

In the present disclosure, the function of quantitative sample injection with a larger or smaller liquid volume may be realized by adjusting the sizes of the housing and the body to meet the volume requirements of the test sample in different systems.

It should be noted that, in the present disclosure, the first chamber has the function of quantitative sample injection and the second chamber has the function of overflow storage. The present disclosure does not impose specific limitations or special requirements on the structures and combination method of the partition plate, the first chamber and the second chamber. For example, when the partition plate takes the form of a hollow column, the housing is divided into a first chamber inside the column and a second chamber outside the column, the first chamber and the second chamber are in an inclusive relationship, and a sample intake column is located inside the first chamber. When the partition plate takes the form of a vertical plate, the housing is divided into a first chamber and a second chamber arranged side by side, and a notch may be provided at the connection between the first chamber and the second chamber, thereby realizing overflowing of the test sample.

As a preferred technical solution of the present disclosure, at least one sample intake column, which is in communication with the gap chamber, is disposed in the first chamber, and during the quantitative sample injection, the sample quantification assembly is continuously pressed down such that the sample intake column extends into the quantitative chamber.

In the present disclosure, the sample intake column may be integrally formed with the housing or may be a separate member assembled at the bottom of the housing.

Preferably, the liquid injection chamber further comprises a sample injection channel running through the sample intake column, and the sample injection channel is connected to the gap chamber of the chip.

It should be noted that the present disclosure does not impose specific limitations or special requirements on the structure of the sample injection channel. For example, the sample injection channel may be a straight or slanted hole running through the sample intake column, a tubular fitting assembled within the sample intake column, or the like.

Preferably, a guide notch is provided at one end of the sample injection channel close to the gap chamber.

Preferably, a venting slot is provided on an inner wall of the housing close to an open end.

It should be noted that in the present disclosure, the length of the venting slot matches the height of the body, and it should be ensured that venting is completed when the sample quantification assembly is pressed down to the bottom of the housing, so that the overflow liquid is sealed within the second chamber.

As a preferred technical solution of the present disclosure, a sealing member is provided at one end of the body that extends into the housing.

It should be noted that during the quantitative sample injection, the body extends into the first chamber and forms a sealed environment with the first chamber via the sealing member, so that the liquid can only flow out of the sample injection channel after being pushed.

Preferably, a groove is provided on the outer wall of the body, and the sealing member is disposed in the groove.

Preferably, the sealing member is an O-shaped sealing ring.

It should be noted that in the present disclosure, at the beginning of sample injection, the sample quantification assembly descends slowly at a constant speed by a downward pressure; when the O-shaped ring starts to enter the first chamber, the excess test sample in the first chamber is pressed by the body and overflows into the second chamber; during the continuous descending of the sample quantification assembly, when the O-shaped ring completely enters the first chamber, a sealed environment is formed, and the volume of the test sample in the first chamber is basically constant; and as the sample quantification assembly continues to be pressed down, the test sample enters the sample injection channel and enters the gap chamber of the chip, and when the body is pressed down to the bottom of the first chamber, the quantitative sample injection is completed.

In the present disclosure, this quantification assembly may be stored in advance in the vacant area of a chip shell or packaged together with the chip, and then placed on the liquid injection chamber after the test sample is initially dropped in.

As a preferred technical solution of the present disclosure, the sample quantification assembly further comprises a base configured to secure the body, and an edge of the base and an inner wall of the housing are in interference fit to achieve a seal during the sample injection.

It should be noted that in the present disclosure, the sample quantification assembly equipped with the sealing member is placed in the liquid injection chamber, and needs to be placed horizontally; and the base of the sample quantification assembly has a magnitude of interference with the inner wall of the housing during the pressing down, which has as a secondary sealing effect.

Preferably, a guide member is further provided on a surface of one side of the base close to the body.

Preferably, a gap is reserved between the body and the guide member, and during the sample injection, the partition plate gradually extends into the gap.

It should be noted that in the present disclosure, the guide member causes the sample quantification assembly to descend vertically, avoiding the situation where the body is shifted or tilted, resulting in a deviation of liquid injection, or where the body is stuck and unable to be pressed down.

Preferably, a venting through-hole is provided in a surface of the base.

Preferably, a venting notch is provided at an outer periphery of the base.

It should be noted that a person skilled in the field may, depending on the specific situation, choose to form the venting through-hole in the surface of the base or the venting notch at the outer periphery of the base to discharge gas.

As a preferred technical solution of the present disclosure, the sample intake column is higher than the partition plate.

Preferably, a gap is reserved between an outer wall of the sample intake column and an inner wall of the quantitative chamber, and the test sample flows within the gap.

As a preferred technical solution of the present disclosure, a stepped groove is provided on a surface of one side of the partition plate close to the sample quantification assembly.

It should be noted that in the present disclosure, the stepped groove at the top of the partition plate serves as a buffer.

Preferably, the stepped groove is divided into a first groove and a second groove in a direction along which the body extends into the first chamber, the first groove has a greater width than the second groove, and the test sample is located at a joint between the first groove and the second groove.

It should be noted that before starting the sample injection, the system device provided in the present disclosure injects the test sample into the first chamber of the liquid injection chamber, and the test sample is quantitatively dropped to the joint between the first groove and the second groove, at which time since the sample intake column is higher than the first chamber, liquid cannot enter the sample injection channel temporarily, and during the subsequent sample injection, the sample quantification assembly is pressed down, part of the test sample is gradually pushed into the space between the sample intake column and the quantitative chamber, and then enters the sample injection channel and flows into the gap chamber.

In a second aspect, the present disclosure provides a method for quantitatively injecting a test sample into a chip. The method uses a system device according to the first aspect, and the method comprises:

injecting a test sample into a first chamber; placing a sample quantification assembly in a liquid injection chamber; and continuously pressing down the sample quantification assembly such that a body is delivered into a first chamber from an open end of a housing, part of the test sample in the first chamber overflows to a second chamber, and the test sample entering a quantitative chamber flows into a gap chamber to achieve quantitative sample injection.

As a preferred technical solution of the present disclosure, the quantitative sample injection specifically comprises:

continuously pressing down the sample quantification assembly to cause the sample intake column to gradually extend into the quantitative chamber such that the test sample is pushed into a gap between the sample intake column and the quantitative chamber and then flows into the gap chamber through the sample injection channel.

Preferably, the method comprises injecting the test sample into the first chamber by means of a collection tube.

Preferably, the operation of pressing down the body comprises using an electric motor or a lifting mechanism to realize automatic pressing-down.

As a preferred technical solution of the present disclosure, the method further comprises venting during the quantitative sample injection.

Preferably, a venting through-hole provided in a surface of the base is used for venting.

Preferably, a venting notch provided at an outer periphery of the base is used for venting.

Preferably, a venting slot on an inner wall of the housing is used for venting.

Illustratively, the method for quantitatively injecting a test sample into a chip provided in the present disclosure specifically comprises steps of:
(1) dropping the test sample into the first chamber using a collection tube until the liquid level of the test sample rises to the joint between the first groove and the second groove at the top of the partition plate, at which time the test sample liquid is temporarily unable to enter the sample injection channel because the sample intake column is higher than the partition plate;
(2) after the dropping of the test sample, horizontally placing the sample quantification assembly equipped with an O-shaped ring in the liquid injection chamber, where the body is placed close to the sample intake column; and
(3) pressing down the sample quantification assembly by means of an electric motor or a lifting mechanism to make it descend slowly at a constant speed, and venting through the venting slot on the inner wall of the housing. In this step, during descending of the sample quantification assembly, when the O-shaped ring starts to enter the first chamber, the edge of the base and the inner wall of the housing are in interference fit to achieve a seal, the excess test sample in the first chamber is pressed by the body and overflows into the second chamber; during the continuous descending of the sample quantification assembly, when the O-shaped ring completely enters the first chamber, a sealed environment is formed, the partition plate gradually extends into the gap between the body and the guide member, and the volume of the test sample in the first chamber is basically constant; and as the sample quantification assembly continues to be pressed down, the test sample enters the sample injection channel and enters the gap chamber of the chip, and when the body is pressed down to the bottom of the first chamber, the quantitative sample injection is completed.

In a third aspect, the present disclosure provides a use of a system device according to the first aspect. The system device is used for injecting a test sample into a gap chamber of a digital microfluidic chip.

In the present disclosure, the digital microfluidic chip adopts the principle of electrowetting technology, regulates solid-liquid surface energy by means of electric potential, and drives a liquid to move by virtue of the surface energy imbalance, so as to achieve precise control on micro-liquid. The main components include: a transparent conductive cover (e.g., of ITO glass) and an electrode array comprising a hydrophobic layer and a dielectric layer on a surface thereof, and a gap chamber for droplet movement is provided between the transparent conductive cover and the electrode array. The surface of the electrode array is provided with the system device for quantitatively injecting a test sample into a chip of the present disclosure, and a sample intake column is in communication with the gap chamber through a sample injection channel.

The system refers to an equipment system, a device system or a production device.

Compared with the prior art, the beneficial effects of the present disclosure are as follows:
the present disclosure provides a system device and method for quantitatively injecting a test sample into a chip, and a use; during use of the system device, the sample quantification assembly that comes with the system device may be used to complete quantitative extraction of the required test sample without the need for an additional quantification tool, and to quantitatively inject the test sample, thereby realising automatic injection of the sample into the chip, reducing the dependence on the additional quantification tool, and making the operation more convenient and flexible.

### BRIEF DESCRIPTION OF THE DRAWINGS

FIG. 1 is a schematic structural diagram of a system device for quantitatively injecting a test sample into a chip provided in Example 1 of the present disclosure;

FIG. 2 is a schematic structural diagram of a sample quantification assembly provided in Example 1 of the present disclosure;

FIG. 3 is a schematic structural diagram of a liquid injection chamber provided in Example 1 of the present disclosure;

FIG. 4 is a schematic diagram of the sample quantification assembly entering the liquid injection chamber provided in Example 1 of the present disclosure;

FIG. 5 is a schematic structural diagram of a digital microfluidic chip provided in Application Example 1 of the present disclosure; and

FIG. 6 is a schematic flowchart of quantitative sample injection provided in Application Example 1 of the present disclosure.

In the figures, 1—sample quantification assembly; 2—liquid injection chamber; 3—body; 4—O-shaped sealing ring; 5—quantitative chamber; 6—guide member; 7—housing; 8—partition plate; 9—first chamber; 10—second chamber; 11—sample intake column; 12—sample injection channel; 13—stepped groove; 14—gap chamber; 15—electrode array; 16—hydrophobic layer; 17—dielectric layer; 18—transparent conductive cover.

### DETAILED DESCRIPTION OF EMBODIMENTS

It should be understood that, in the description of the present disclosure, orientation or position relationships indicated by terms such as “center”, “longitudinal”, “transverse”, “up”, “down”, “front”, “rear”, “left”, “right”, “vertical”, “horizontal”, “top”, “bottom”, “inside”, and “outside” are based on orientation or position relationships shown in the accompanying drawings and are merely for ease of description of the present disclosure and simplification of the description, rather than indicating or implying that the apparatuses or elements referred to must have a specific orientation or be constructed and operated in a specific orientation, and therefore cannot be construed as limiting the present disclosure. In addition, the terms such as “first” and “second” are used for descriptive purposes only, and cannot be construed as indicating or implying relative importance or implicitly indicating the number of technical features indicated. Thus, the features defined with “first”, “second” and so on may explicitly or implicitly include one or more features. In the description of the present disclosure, unless otherwise specified, “a plurality of” means two or more.

It should be noted that in the description of the present disclosure, unless otherwise explicitly specified and defined, the terms “arranged”, “connected” and “connect” should be understood in a broad sense, for example, they may be a fixed connection, a detachable connection, or an integrated connection; may be a mechanical connection or an electrical connection; or may be a direct connection, an indirect connection by means of an intermediate medium, or internal communication between two elements. For those of ordinary skill in the art, the specific meaning of the terms mentioned above in the present disclosure can be construed according to specific circumstances.

The technical solution of the present disclosure will be further described below in specific implementations with reference to the drawings.

In a specific embodiment, the present disclosure provides a system device for quantitatively injecting a test sample into a chip. The system device is configured to inject a quantitative test sample into a gap chamber 14 of a chip. The system device comprises a sample quantification assembly 1 and a liquid injection chamber 2. The sample quantification assembly 1 comprises a body 3, and a quantitative chamber 5 is provided in the body 3. The liquid injection chamber 2 comprises an open housing 7, a partition plate 8 is provided in the housing 7, the partition plate 8 divides the housing 7 into a first chamber 9 and a second chamber 10, and the test sample is injected into the first chamber 9. The sample quantification assembly 1 is placed in the liquid injection chamber 2 and is continuously pressed down such that the body 3 extends into the first chamber 9 for quantitative sample injection.

In the present disclosure, the function of quantitative sample injection with a larger or smaller liquid volume may be realized by adjusting the sizes of the housing 7 and the body 3 to meet the volume requirements of the sample in different systems.

In the present disclosure, the first chamber 9 has the function of quantitative sample injection and the second chamber 10 has the function of overflow storage. The present disclosure does not impose specific limitations or special requirements on the structures and combination method of the partition plate 8, the first chamber 9 and the second chamber 10. For example, when the partition plate 8 takes the form of a hollow column, the housing 7 is divided into a first chamber 9 inside the column and a second chamber 10 outside the column, the first chamber 9 and the second chamber 10 are in an inclusive relationship, and a sample intake column 11 is located inside the first chamber 9. When the partition plate 8 takes the form of a vertical plate, the housing 7 is divided into a first chamber 9 and a second chamber 10 arranged side by side, and a notch may be provided at a connection between the first chamber 9 and the second chamber 10, thereby realizing overflowing of the test sample.

Further, at least one sample intake column 11, which is in communication with the gap chamber 14, is disposed in the first chamber 9, and during the quantitative sample injection, the sample quantification assembly 1 is continuously pressed down such that the sample intake column 11 extends into the quantitative chamber 5. In the present disclosure, the sample intake column 11 may be integrally formed with the housing 7 or may be a separate member assembled at the bottom of the housing 7.

The liquid injection chamber 2 further comprises a sample injection channel 12 running through the sample intake column 11, and the sample injection channel 12 is connected to the gap chamber 14 of the chip. The present disclosure does not impose specific limitations or special requirements on the structure of the sample injection channel 12. For example, the sample injection channel may be a straight or slanted hole running through the sample intake column 11, a tubular fitting assembled within the sample intake column 11, or the like.

A guide notch is provided at one end of the sample injection channel 12 close to the gap chamber 14.

A venting slot is provided on an inner wall of the housing 7 close to an open end. In the present disclosure, the length of the venting slot matches the height of the body 3, and it should be ensured that venting is completed when the sample quantification assembly 1 is pressed down to the bottom of the housing 7, so that the overflow liquid is sealed within the second chamber 10.

Further, a sealing member is provided at one end of the body 3 that extends into the housing 7. During the quantitative sample injection, the body 3 extends into the first chamber 9 and forms a sealed environment with the first chamber 9 via the sealing member, so that the liquid can only flow out of the sample injection channel 12 after being pushed.

A groove is provided on the outer wall of the body 3, and the sealing member is disposed in the groove.

The sealing member is an O-shaped sealing ring 4. In the present disclosure, at the beginning of sample injection, the sample quantification assembly 1 descends slowly at a constant speed by a downward pressure; during the initial descending of the sample quantification assembly, when the O-shaped ring has not yet served as a seal, the excess test sample in the first chamber 9 is pushed into the second chamber 10 by the body 3 of the sample quantification assembly 1; during the continuous descending of the sample quantification assembly, when the O-shaped ring begins to achieve primary sealing, the volume of the test sample in the first chamber 9 is basically constant; and as the sample quantification assembly continues to be pressed down, the sample enters the gap chamber 14 of the chip through the sample intake column 11, and when the sample quantification assembly 1 is pressed down to the bottom, the quantitative sample injection is completed.

In the present disclosure, this quantification assembly may be stored in advance in the vacant area of a chip shell or packaged together with the chip, and then placed on the liquid injection chamber after the test sample is initially dropped in.

Further, the sample quantification assembly 1 further comprises a base configured to secure the body 3, and an edge of the base and an inner wall of the housing 7 are in interference fit to achieve a seal during the sample injection. In the present disclosure, the sample quantification assembly 1 equipped with the sealing member is placed in the liquid injection chamber 2, and needs to be placed horizontally; and the base of the sample quantification assembly 1 has a magnitude of interference with the inner wall of the housing 7 during the pressing down, which has as a secondary sealing effect.

A guide member 6 is further provided on a surface of one side of the base close to the body 3. A gap is reserved between the body 3 and the guide member 6, and during the sample injection, the partition plate 8 gradually extends into the gap. In the present disclosure, the guide member 6 causes the sample quantification assembly 1 to descend vertically, avoiding the situation where the body 3 is shifted or tilted, resulting in a deviation of liquid injection, or where the body is stuck and unable to be pressed down.

A venting through-hole is provided in a surface of the base.

A venting notch is provided at an outer periphery of the base.

Further, the sample intake column 11 is higher than the partition plate 8.

A gap is reserved between an outer wall of the sample intake column 11 and an inner wall of the quantitative chamber 5, and the test sample flows within the gap.

Further, a stepped groove 13 is provided on a surface of one side of the partition plate 8 close to the sample quantification assembly 1. The stepped groove 13 is divided into a first groove and a second groove in a direction along which the body 3 extends into the first chamber 9, the first groove has a greater width than the second groove, and the test sample is located at a joint between the first groove and the second groove.

Before starting the sample injection, the system device provided in the present disclosure injects the test sample into the first chamber 9 of the liquid injection chamber 2, and the test sample is quantitatively dropped to the joint between the first groove and the second groove, at which time since the sample intake column 11 is higher than the first chamber 9, liquid cannot enter the sample injection channel 12 temporarily, and during the subsequent sample injection, the sample quantification assembly 1 is pressed down, part of the test sample is gradually pushed into the space between the sample intake column 11 and the quantitative chamber 5, and then enters the sample injection channel 12 and flows into the gap chamber 14.

In another specific embodiment, the present disclosure provides a method for quantitatively injecting a test sample into a chip. The method uses a system device according to the first aspect, and the method comprises:

injecting a test sample into a first chamber 9; placing a sample quantification assembly 1 in a liquid injection chamber 2; and continuously pressing down the sample quantification assembly 1 such that a body 3 is delivered into a first chamber 9 from an open end of a housing 7, part of the test sample in the first chamber 9 overflows to a second chamber 10, and the test sample entering a quantitative chamber 5 flows into a gap chamber 14 to achieve quantitative sample injection.

Further, the quantitative sample injection specifically comprises:

continuously pressing down the sample quantification assembly 1 to cause the sample intake column 11 to gradually extend into the quantitative chamber 5 such that the test sample is pushed into a gap between the sample intake column 11 and the quantitative chamber 5 and then flows into the gap chamber 14 through the sample injection channel 12.

The method comprises injecting the test sample into the first chamber 9 by means of a collection tube. The injected test sample is located at the joint between the first groove and the second groove.

The operation of pressing down the body 3 comprises using an electric motor or a lifting mechanism to realize automatic pressing-down.

Further, the method further comprises venting during the quantitative sample injection.

A venting through-hole provided in a surface of the base is used for venting.

A venting notch provided at an outer periphery of the base is used for venting.

A venting slot on an inner wall of the housing 7 is used for venting.

### Example 1

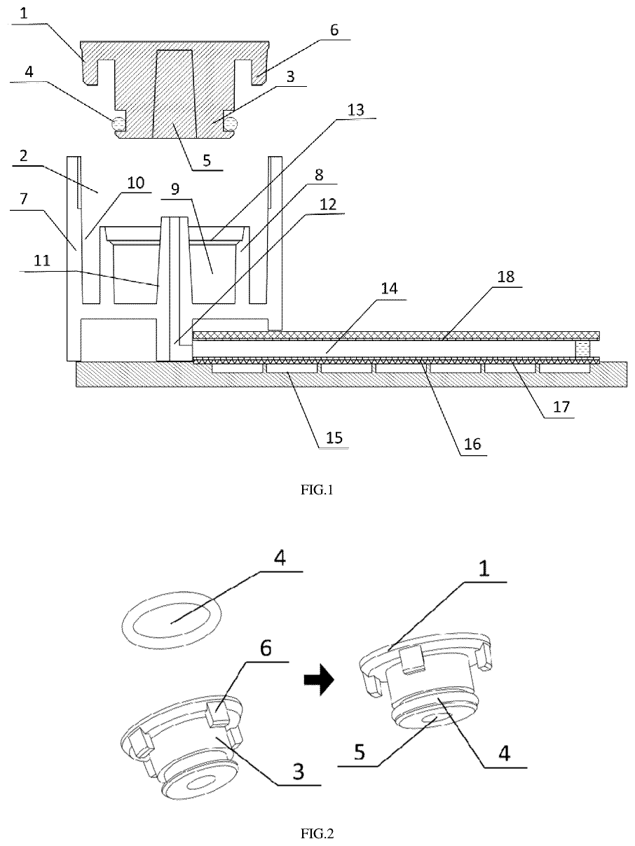

The present embodiment provides a system device for quantitatively a test sample into a chip. As shown in FIG. 1, the system device comprises a sample quantification assembly 1 and a liquid injection chamber 2. As shown in FIG. 2, the sample quantification assembly 1 comprises a body 3, a quantitative chamber 5 is provided in the body 3, a groove is provided on an outer wall of the body 3, and an O-shaped sealing ring 4 is disposed in the groove. The sample quantification assembly 1 further comprises a base configured to secure the body 3, and during sample injection, an edge of the base and an inner wall of the housing 7 are in interference fit to achieve a seal. Four guide members 6 are provided on a surface of one side of the base close to the body 3, and a gap is reserved between the body 3 and the guide members 6.

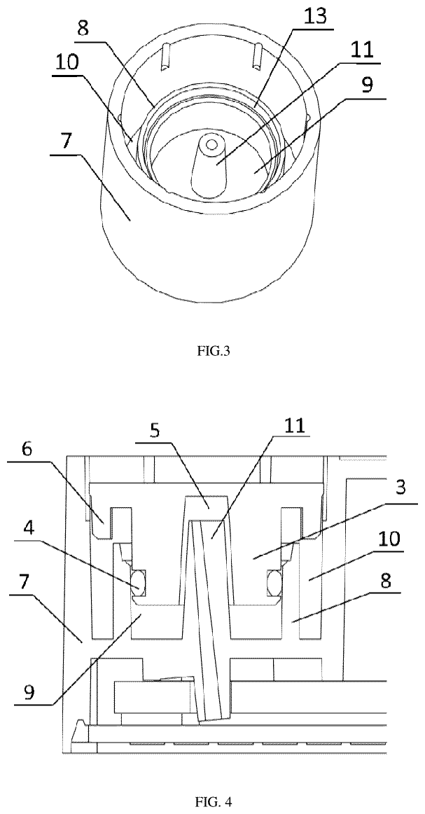

As shown in FIG. 3, the liquid injection chamber 2 comprises an open housing 7, a partition plate 8 is provided in the housing 7, the partition plate 8 is a hollow column, the partition plate 8 divides the housing 7 into a first chamber 9 and a second chamber 10, and a sample intake column 11, which is in communication with a gap chamber 14, is disposed in the first chamber 9. The liquid injection chamber 2 further comprises a sample injection channel 12 running through the sample intake column 11, the sample injection channel 12 is connected to the gap chamber 14 of the chip, and a guide notch is provided at one end of the sample injection channel 12 close to the gap chamber 14. A venting slot is provided on an inner wall of the housing 7 close to the open end, as shown in FIG. 3.

As shown in FIG. 4, the sample intake column 11 is higher than the partition plate 8, a gap is reserved between an outer wall of the sample intake column 11 and an inner wall of the quantitative chamber 5, and the test sample flows within the gap.

A stepped groove 13 is provided on a surface of one side of the partition plate 8 close to the sample quantification assembly 1, the stepped groove 13 is divided into a first groove and a second groove in a direction along which the body 3 extends into the first chamber 9, the first groove has a greater width than the second groove, and the test sample is located at a joint between the first groove and the second groove.

### Application Example 1

In this application example, a system device for quantitatively injecting a test sample into a chip provided in Example 1 is used for injecting a reagent into a gap chamber 14 of a digital microfluidic chip as shown in FIG. 5. The main components of the digital microfluidic chip in this application example comprise: a transparent conductive cover 18, and an electrode array 15 comprising a hydrophobic layer 16 and a dielectric layer 17 on a surface thereof, and the gap chamber 14 for droplet movement is provided between the transparent conductive cover 18 and the electrode array 15. The surface of the electrode array 15 is provided with the system device for quantitatively injecting a test sample into a chip of the present disclosure, and a sample intake column 11 is in communication with the gap chamber 14 through a sample injection channel 12.

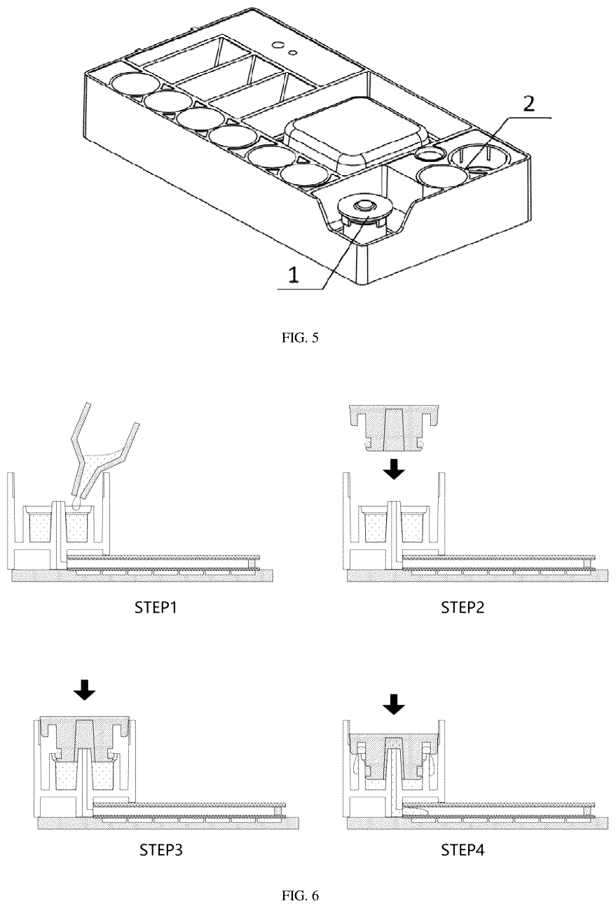

As shown in FIG. 6, the quantitative sample injection specifically comprises steps of:
(1) dropping the test sample into the first chamber 9 using a collection tube until the liquid level of the test sample rises to the joint between the first groove and the second groove at the top of the partition plate 8, at which time the test sample liquid is temporarily unable to enter the sample injection channel 12 because the sample intake column 11 is higher than the partition plate 8;
(2) after the dropping of the test sample, horizontally placing the sample quantification assembly 1 equipped with an O-shaped ring in the liquid injection chamber 2, where the body 3 is placed close to the sample intake column 11; and
(3) pressing down the sample quantification assembly 1 by means of an electric motor or a lifting mechanism to make it descend slowly at a constant speed, and venting through the venting slot on the inner wall of the housing 7. In this step, during descending of the sample quantification assembly, when the O-shaped ring starts to enter the first chamber 9, the edge of the base and the inner wall of the housing 7 are in interference fit to achieve a seal, the guide member 6 extends into the second chamber 10, the excess test sample in the first chamber 9 is pressed by the body 3 and overflows into the second chamber 10; during the continuous descending of the sample quantification assembly, when the O-shaped ring completely enters the first chamber 9, a sealed environment is formed, the partition plate 8 gradually extends into the gap between the body 3 and the guide member 6, and the volume of the test sample in the first chamber 9 is basically constant; and as the sample quantification assembly continues to be pressed down, the test sample enters the sample injection channel 12 and enters the gap chamber 14 of the chip, and when the body 3 is pressed down to the bottom of the first chamber 9, the quantitative sample injection is completed.
(1) Sealing and liquid injection accuracy tests for the sample quantification assembly 1 were carried out specifically by the following steps:
1. weighing EP tubes, marking serial numbers, and recording the weights;
2. measuring the critical size of a cell and the sample quantification assembly 1 and marking serial numbers;
3. injecting liquid into the sample quantification assembly 1 with a pipette, placing a sample quantification plug equipped with an O-shaped ring on the top, and receiving the ejected liquid by means of an EP tube below, manually pressing it down, weighing the EP tube that receives the liquid, recording data, and calculating the difference, where results are shown in Table 1; and
4. tidying up an experiment table at the end of the experiment.

TABLE 1

| | Weight of | Weight of | Weight of | | Weight of | Weight of | Weight of |
|---|---|---|---|---|---|---|---|
| | empty EP | (EP tube + | injected | | empty EP | (EP tube + | injected |
| No. | tube/g | liquid)/g | sample/g | No. | tube/g | liquid)/g | sample/g |
| 1 | 0.1616 | 0.3275 | 0.1659 | 21 | 0.1613 | 0.3331 | 0.1718 |
| 2 | 0.1620 | 0.3374 | 0.1754 | 22 | 0.1608 | 0.3288 | 0.1680 |
| 3 | 0.1610 | 0.3257 | 0.1647 | 23 | 0.1622 | 0.3365 | 0.1743 |
| 4 | 0.1612 | 0.3314 | 0.1702 | 24 | 0.1616 | 0.3338 | 0.1722 |
| 5 | 0.1612 | 0.3339 | 0.1727 | 25 | 0.1614 | 0.3281 | 0.1667 |
| 6 | 0.1608 | 0.3359 | 0.1751 | 26 | 0.1622 | 0.333 | 0.1708 |
| 7 | 0.1609 | 0.3365 | 0.1756 | 27 | 0.1617 | 0.3375 | 0.1758 |
| 8 | 0.1616 | 0.3375 | 0.1759 | 28 | 0.1615 | 0.3313 | 0.1698 |
| 9 | 0.1609 | 0.3309 | 0.1700 | 29 | 0.1618 | 0.3363 | 0.1745 |
| 10 | 0.1609 | 0.3309 | 0.1700 | 30 | 0.1610 | 0.3359 | 0.1749 |
| 11 | 0.1620 | 0.3372 | 0.1752 | 31 | 0.1604 | 0.3272 | 0.1668 |
| 12 | 0.1613 | 0.3366 | 0.1753 | 32 | 0.1614 | 0.3316 | 0.1702 |
| 13 | 0.1611 | 0.3343 | 0.1732 | 33 | 0.1617 | 0.3389 | 0.1772 |
| 14 | 0.1623 | 0.3340 | 0.1717 | 34 | 0.1612 | 0.3321 | 0.1709 |
| 15 | 0.1608 | 0.3305 | 0.1697 | 35 | 0.1611 | 0.3386 | 0.1775 |
| 16 | 0.1614 | 0.3263 | 0.1649 | 36 | 0.1610 | 0.3356 | 0.1746 |
| 17 | 0.1615 | 0.3342 | 0.1727 | 37 | 0.1611 | 0.3325 | 0.1714 |
| 18 | 0.1624 | 0.3357 | 0.1733 | 38 | 0.1610 | 0.3298 | 0.1688 |
| 19 | 0.1612 | 0.3298 | 0.1686 | 39 | 0.1603 | 0.3376 | 0.1773 |
| 20 | 0.1606 | 0.3346 | 0.1740 | 40 | 0.1613 | 0.3335 | 0.1722 |

(2) Pressure test for the sample quantification assembly 1 was carried out specifically by the following steps:
1. placing the liquid injection chamber 2 directly under a press head of a press machine;
2. injecting sample liquid into the liquid injection chamber 2 to the vicinity of the stepped groove 13 (with the liquid level being located at the joint between the first groove and the second groove);
2. placing the sample quantification assembly 1 equipped with the O-shaped ring over the liquid injection chamber 2;
3. starting the press machine for downward pressing; and
4. observing and recording the pressure value during downward pressing, where results are shown in Table 2.

TABLE 2

| No. | Pressure value (N) |
|---|---|
| 1 | 152.3 |
| 2 | 136.1 |
| 3 | 158.7 |
| 4 | 156.6 |
| 5 | 150.3 |
| 6 | 162.4 |
| 7 | 139.5 |
| 8 | 143.4 |
| 9 | 162.3 |
| 10 | 141.2 |
| 11 | 138.4 |
| 12 | 144.7 |
| 13 | 145.1 |
| 14 | 150.4 |
| 15 | 153.9 |
| 16 | 141.5 |
| 17 | 134.7 |
| 18 | 136.6 |
| 19 | 131.8 |
| 20 | 139.6 |

As can be seen from Table 1, the test sample range of forty sets of data is 12.8 μL, and the injection accuracy meets the requirements; and the sample quantification assembly 1 provided in the present disclosure has good sealing, and the test sample can be injected into the gap chamber 14 of the chip from the sample injection channel 12 as expected. As can be seen from Table 2, the average value of the downward pressure required for the sample quantification assembly 1 is 145.975N, the maximum pressure value is 158.7N, and the minimum pressure value is 131.8N.

According to the present disclosure, during use of the system device for quantitatively injecting a test sample into a chip, the sample quantification assembly 1 that comes with the system device may be used to complete quantitative extraction of the required test sample without the need for an additional quantification tool, and to quantitatively inject the test sample, thereby realizing automatic injection of the sample into the chip, reducing the dependence on the additional quantification tool, and making the operation more convenient and flexible.

The applicant gives notice that the foregoing descriptions are only specific implementations of the present disclosure, but the scope of protection of the present disclosure is not intended thereto. Those skilled in the pertinent technical field shall understand that any variations or replacements that can be easily conceived by a person skilled in the art within the technical scope disclosed in the present disclosure shall fall within the scope of protection of the present disclosure.

1. A system device for quantitatively injecting a test sample into a chip, the system device being configured to inject a quantitative test sample into a gap chamber of a chip, wherein the system device comprises:
a sample quantification assembly comprising a body, a quantitative chamber being provided in the body; and
a liquid injection chamber comprising an open housing, a partition plate being provided in the housing, the partition plate dividing the housing into a first chamber and a second chamber, and the first chamber being configured to accommodate the injected test sample,
wherein the sample quantification assembly is configured to be pressed into the liquid injection chamber such that the body extends into the first chamber for quantitative sample injection.

2. The system device according to claim 1, wherein at least one sample intake column, which is in communication with the gap chamber, is disposed in the first chamber, and the at least one sample intake column is configured to extend into the quantitative chamber.

3. The system device according to claim 1, wherein a sealing member is disposed on an outer wall of the body.

4. The system device according to claim 1, wherein the sample quantification assembly further comprises a base configured to secure the body, and an edge of the base is configured to be in interference fit with the inner wall of the housing during sample injection.

5. The system device according to claim 2, wherein the sample intake column is higher than the partition plate; and a gap is reserved between an outer wall of the sample intake column and an inner wall of the quantitative chamber when the sample intake column extends into the quantitative chamber.

6. The system device according to claim 1, wherein a stepped groove is provided on a surface of one side of the partition plate close to the sample quantification assembly; and the stepped groove comprises a first groove and a second groove in a direction along which the body extends into the first chamber, and the first groove has a greater width than the second groove.

7. A method for quantitatively injecting a test sample into a chip, the method using a system device according to claim 1, the method comprising:
injecting a test sample into a first chamber;
placing a sample quantification assembly in a liquid injection chamber; and
continuously pressing down the sample quantification assembly such that a body is delivered into a first chamber from an open end of a housing, part of the test sample in the first chamber overflows to a second chamber, and the test sample entering a quantitative chamber flows into a gap chamber to achieve quantitative sample injection.

8. The method according to claim 7, wherein at least one sample intake column, which is in communication with the gap chamber, is disposed in the first chamber, the sample intake column comprises a sample injection channel which runs through the sample intake column and is in communication with the gap chamber, and the quantitative sample injection comprises:
continuously pressing down the sample quantification assembly to cause the sample intake column to gradually extend into the quantitative chamber to push the test sample into a gap between the sample intake column and the quantitative chamber, such that the test sample flows into the gap chamber through the sample injection channel.

9. The method according to claim 7, further comprising venting during the quantitative sample injection.

10. (canceled)

11. A system device for quantitatively injecting a test sample into a chip, the system device being configured to inject a quantitative test sample into a gap chamber of a chip, the system device comprising a liquid injection chamber, wherein the liquid injection chamber comprises:
an open housing;
a partition plate disposed in the housing, the partition plate dividing the housing into a first chamber and a second chamber, the first chamber being configured to accommodate the test sample injected therein and accommodate an assembly which is pressed into the first chamber and forms a seal with an inner wall thereof, and the second chamber being configured to store the sample overflowing from the first chamber; and
at least one sample intake column disposed in the first chamber, a sample injection channel in the sample intake column being configured to communicate the first chamber with the gap chamber of the chip, wherein the sample intake column is higher than the partition plate.

12. The system device according to claim 11, wherein a stepped groove is provided on a surface of one side of the partition plate close to the open end of the housing, the stepped groove comprises a first groove and a second groove in a direction toward the inside of the housing, and the first groove has a greater width than the second groove.

13. The system device according to claim 11, wherein a venting slot is provided on an inner wall of the housing close to an open end.

14. A sample quantification assembly for quantitatively injecting a test sample into a chip, the sample quantification assembly comprising:
a body, wherein a quantitative chamber is provided in the body, the body is configured to be pressed into a chamber filled with the test sample, and the quantitative chamber is configured to accommodate a sample intake column disposed in the chamber; and
a base fixed to the body.

15. The sample quantification assembly according to claim 14, wherein a groove is provided on an outer wall of the body and configured to mount a sealing member.

16. The sample quantification assembly according to claim 14, wherein a guide member is provided on a surface of one side of the base close to the body; wherein:
a gap is reserved between the body and the guide member;
a venting through-hole is provided in a surface of the base; and/or
a venting notch is provided at an outer periphery of the base.

17. The system device according to claim 2, wherein:
the liquid injection chamber further comprises a sample injection channel running through the sample intake column, and the sample injection channel is configured to be connected to the gap chamber of the chip;
a guide notch is provided at one end of the sample injection channel close to the gap chamber; and/or
a venting slot is provided on an inner wall of the housing close to an open end.

18. The system device according to claim 3, wherein:
a groove is provided on the outer wall of the body, and the sealing member is disposed in the groove; and/or
the sealing member is an O-shaped sealing ring.

19. The system device according to claim 4, wherein:
a guide member is further provided on a surface of one side of the base close to the body;
a gap is reserved between the body and the guide member, and the gap is configured to accommodate the partition plate during the sample injection;
a venting through-hole is provided in a surface of the base; and/or
a venting notch is provided at an outer periphery of the base.

20. The system device according to claim 8, wherein:
the method comprises injecting the test sample into the first chamber by means of a collection tube;
the injected test sample is located at a joint between a first groove and a second groove on a surface of one side of the partition plate close to the sample quantification assembly; and/or
the method further comprises pressing down the sample quantification assembly by means of an electric motor or a lifting mechanism.

21. The system device according to claim 9, wherein:
a venting through-hole provided in a surface of a base of the sample quantification assembly is used for venting;
a venting notch provided at an outer periphery of the base of the sample quantification assembly is used for venting; and/or
a venting slot on an inner wall of the housing is used for venting.
